(19) United States
(12) Patent Application Publication
(10) Pub. No.: US 2025/0139265 A1
(43) Pub. Date: May 1, 2025

(54) STORAGE METHOD

(71) Applicant: STMICROELECTRONICS INTERNATIONAL N.V., Geneva (CH)

(72) Inventor: Laurent TABARIES, AUBAGNE (FR)

(21) Appl. No.: 18/920,513

(22) Filed: Oct. 18, 2024

(30) Foreign Application Priority Data
Oct. 25, 2023 (FR) 2311617

(51) Int. Cl. G06F 21/62; G06F 21/60

(52) U.S. Cl. CPC G06F 21/6209; G06F 21/602

(57) ABSTRACT

The present disclosure provides a method of storing a data item in an electronic system comprising at least two secure elements, comprising the following successive steps: dividing the data item into at least two parts; and distributing and storing each of the at least two parts into one of the at least two secure elements.

### CROSS REFERENCE TO RELATED APPLICATION(S)

This application claims the priority benefit of French patent application number FR2311617, filed on Oct. 25, 2023, entitled “Procédé de stockage”, which is hereby incorporated by reference to the maximum extent allowable by law.

### TECHNICAL FIELD

The present disclosure generally concerns electronic systems and devices. More particularly, the present disclosure relates to the storage of sensitive data in an electronic system.

### BACKGROUND

Currently, many electronic systems and devices use sensitive data, and particularly encryption and/or decryption keys or application keys, and, for this purpose, sometimes need to store them. It may be important to securely store these data.

It would be desirable to be able to improve, at least partly, certain aspects of the storage of sensitive data in an electronic system.

### BRIEF SUMMARY

There exists a need for a more secure storage of sensitive data in a electronic system.

There exists a need for electronic systems more securely storing sensitive data.

An embodiment overcomes all or part of the disadvantages of known methods for storing sensitive data in an electronic system.

An embodiment overcomes all or part of the disadvantages of known electronic systems for securely storing sensitive data.

An embodiment provides a method of storing a sensitive data item in an electronic system using a plurality of secure elements.

An embodiment provides an electronic system storing a sensitive data item by distributing it into a plurality of secure elements.

An embodiment provides a method of storing a data item in an electronic system comprising at least two secure elements, comprising the following successive steps:
dividing the data item into at least two parts; and
distributing and storing each of the at least two parts into one of the at least two secure elements.

Another embodiment provides an electronic system, comprising at least two secure elements, and adapted to storing a data item by following the following successive steps:
dividing the data item into at least two parts; and
distributing and storing each of the at least two parts into one of the at least two secure elements.

According to an embodiment, the distribution of the at least two parts into the at least two secure elements is recorded in a row, or a column, of a lookup table.

According to an embodiment, the lookup table is stored in a single location of the system accessible to each of the at least two secure elements.

According to an embodiment, a copy of the lookup table is stored in each of the at least two secure elements.

According to an embodiment, the distribution is different for each data item stored in the system.

According to an embodiment, the distribution is selected by selecting a row of the lookup table.

According to an embodiment, the selection of the row of the lookup table is performed by using a counter.

According to an embodiment, each of the at least two secure elements is included in at least one operating domain of the system.

According to an embodiment, each at least one operating domain further comprises at least one electronic device.

According to an embodiment, the at least two secure elements are on-board secure elements.

According to an embodiment, the data item is an application key.

According to an embodiment, the system is a motor vehicle.

According to an embodiment, the method comprises the following successive steps:
retrieving the at least two parts of the data item stored in the at least two secure elements; and
forming the data item by using the at least two parts.

According to an embodiment, the forming of the data item is performed by using the lookup table.

### BRIEF DESCRIPTION OF THE DRAWINGS

The foregoing features and advantages, as well as others, will be described in detail in the rest of the disclosure of specific embodiments given by way of illustration and not limitation with reference to the accompanying drawings, in which:

FIG. 1 shows an embodiment of an electronic system; and

FIG. 2 shows two block diagrams illustrating an implementation mode of a method of storage and of a method of retrieval of a data item stored in the electronic system of FIG. 1.

### DETAILED DESCRIPTION

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10%, preferably of plus or minus 5%.

The embodiments described hereafter concern the storage of data, and more particularly of a secret or sensitive data item, in an electronic device comprising a plurality of, at least two, secure elements.

There is called hereafter “sensitive” or “secret” a data item representing sensitive and/or secret information, the content of which is not intended to be public.

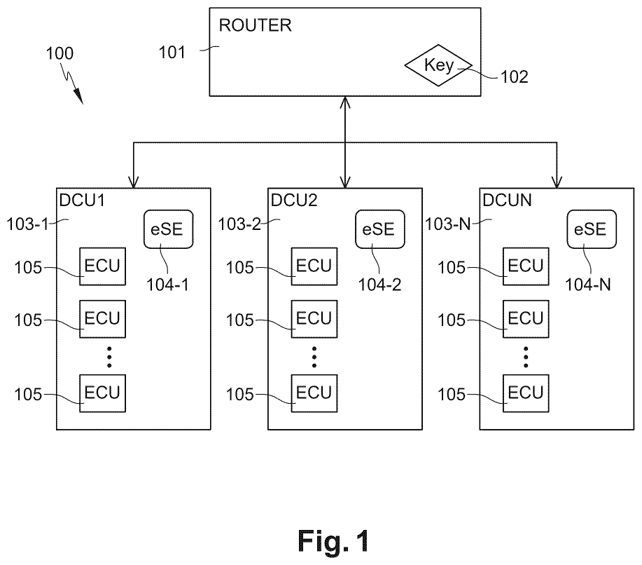

FIG. 1 very schematically shows in the form of blocks an embodiment of a system 100 adapted to securely storing one or a plurality of sensitive and/or secret data items.

System 100 is a complex electronic system such as a computer, or an electronic system of a motor vehicle.

System 100 comprises a router 101 (ROUTER) adapted to receiving and transmitting data. According to an example, router 101 is an Internet communication module, such as a module having access to the fifth generation (5G) cell phone network, or a module having access to the Internet due to a Wi-Fi type wireless communication protocol. Router 101 is thus adapted to receiving and transmitting data within system 100, but also with one or a plurality of other electronic systems external to system 100.

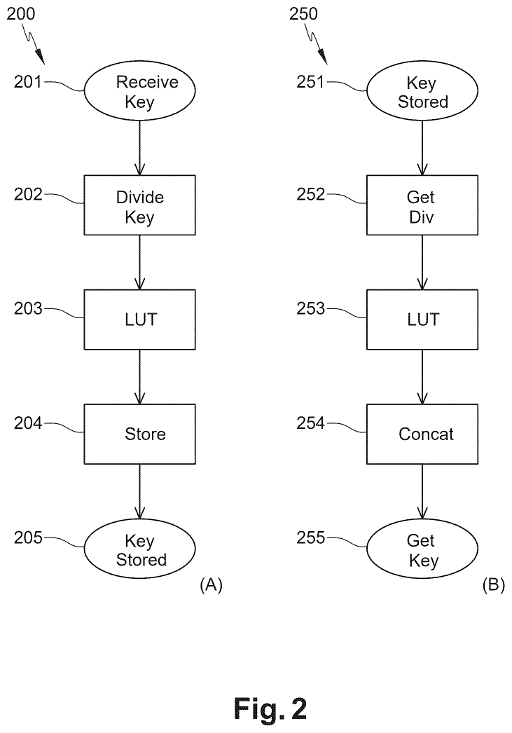

According to an embodiment, router 101 is particularly adapted to receiving one or a plurality of data items 102 (Key) to be stored in system 100. Data item(s) 102 are, for example, sensitive and/or secret data. According to an embodiment, data item(s) 102 are encryption and/or decryption keys, or application keys. There is called herein “application key” a data item enabling to make one or a plurality of functionalities and/or one or a plurality of sets of data of an electronic system accessible. An implementation mode of a method of secure storage of data item 102 and an implementation mode of a method of retrieval of such a stored data item are described in relation with FIG. 2.

System 100 is adapted to implementing a multitude of functionalities which are gathered into a plurality of operating domains. In the example shown in FIG. 1, the system comprises N operating domains 103-1 (DCU1), 103-2 (DCU2), . . . and 103-N (DCUN), N being an integer greater than or equal to two. Each operating domain 103-i, i being an integer varying from 1 to N, comprises at least one secure element 104-i and one or a plurality of, generally a plurality of, electronic devices 105 (CPU), each adapted to implementing one or a plurality of functionalities.

According to a practical example, if system 100 is a motor vehicle, a first operating domain may concern the engine domain, and comprise electronic devices managing, for example, injection, engine operating modes, the sensors enabling to monitor the proper operation and/or the wearing of the engine, etc. A second operating domain may concern safety within the vehicle, and comprise electronic devices managing, for example, tire pressure, brakes, emergency calls, etc. A third operating domain may concern the interior of the vehicle, and comprise electronic devices managing, for example, air conditioning, heating, lighting, etc. A fourth operating domain may concern the multimedia content of the vehicle, and comprise electronic devices managing, for example, a radio or car audio, a sound system, one or a plurality of displays, etc.

Each secure element 104-i comprises one or a plurality of storage means, such as a register or a memory, enabling to securely store data. In particular, each secure element 104-i is resistant to a side channel attack. According to an example, all or part of the secure elements 104-1 to 104-N are embedded secure elements.

FIG. 2 comprises two block diagrams (A) and (B) illustrating an implementation mode of a storage of a data item in the system 100 described in relation with FIG. 1. More particularly, diagram (A) shows an implementation mode of a method 200 of storing a data item in system 100, and diagram (B) shows an implementation mode of a method 250 of retrieving a data item already stored in system 100.

When system 100 needs to securely store a data item of the type of data item 102, method 200 is executed.

At an initial step 201 (Receive Key), system 100 receives a data item Key to be stored, for example of the type of the above-described data item 102.

At a step 202 (Divide Key), subsequent to the initial step 201, data item Key is divided into a plurality of data items, called hereafter parts of data item Key. For this purpose, data item Key is divided, split, segmented, or fractionated into a plurality of parts. More particularly, data item Key is divided, for example, into M parts, M being an integer greater than or equal to two. According to an example, M is the number of secure elements 104-1 to 104-N comprised in system 100. According to an embodiment, M is smaller than or equal to N. According to a preferred embodiment, M is equal to N.

According to an example, when the system 100 is used to store several data, for example several keys of the type of the key Key, different, then it is possible that, at step 202, each data is divided into a different number of parts.

At a step 203 (LUT), subsequent to step 202, a lookup table (LUT) is used to prepare the storage of parts Key1 to KeyM in the system. According to an embodiment, each part Keyj, j being an integer between 1 and M, is stored in a secure element 104-i. According to an embodiment, the distribution of parts Key1 to KeyM in elements 104-1 to 104-N is recorded in a lookup table. According to a first example, the distribution of the parts Key1 to KeyM can be defined by the correspondence table. In the case of this first example, the correspondence table can, for example, comprise all possible combinations of distribution of the parts Key1 to KeyM in the secure elements 104-1 to 104-N, the number N of which varies between 2 and M. According to a second example, the distribution of the parts Key1 to KeyM can be defined previously and then recorded in the correspondence table. In the case of this second example, the distribution of the parts Key1 to KeyM can be defined randomly.

More specifically, each column of the lookup table corresponds to a secure element 104-i, and a row of the lookup table comprises the order in which parts Key1 to KeyM are stored in secure elements 104-1 to 104-N. According to a variant, the rows and columns of the lookup table may be inverted. According to an embodiment, each data item stored in the system comprises a different distribution of these parts in the secure elements.

According to an embodiment, the lookup table comprises a finite number of rows, and for each data item to be stored in the system, a row is selected, for example in secure fashion.

According to a preferred embodiment, the system comprises a counter having a value adapted to selecting a row in the lookup table. This counter may be incremented each time a new data item is stored. Thus, a first data item can be stored by using the information of the row of the lookup table having a number equal to the counter value. Once the storage is complete, the counter is incremented. When a second data item is to be stored, another row having a number equal to the incremented counter value is selected, is stored by using the information of the next row, etc. The counter can be securely stored in system 100.

According to an example, when the system 100 is used to store multiple data, it is possible to use a different number of secure elements to store the parts of each data. All of this information is recorded, for example, in the correspondence table.

Furthermore, according to another example, the number of secure elements used for storage may vary depending on the data to be stored but also depending on the operating session of the system 100. More particularly, an operating session is defined as being a finite duration of use in a distinct operating mode of the system 100, for example a secure operating mode. For example, during an operating session having a higher security level, a greater number of secure elements may be used.

Changing the distribution of the parts of the data item in the secure elements for each data item enables to make the storage process resistant to side channel attacks. Indeed, each storage, in this case, has a different electrical signature.

According to an example, the lookup table may be stored in router 102, while being accessible to at least one of the secure elements 104-1 to 104-N, or to all the secure elements 104-1 to 104-N. According to a variant, each secure element 104-1 to 104-N stores a copy of the lookup table.

At a step 204 (Store), subsequent to step 203, the storage of each part Key1 to KeyM in secure elements 104-1 to 104-N is implemented.

At a step 205 (Key Stored), subsequent to step 204, the data item is securely stored in system 100.

Conversely, to retrieve a data item stored in system 100 by using storage method 200, method 250 is executed.

At an initial step 251 (Key Stored), data item Key was stored in system 100. For this purpose, data item Key was divided into M parts Key1 to KeyM, and each of these parts was stored in a secure element of system 100.

At a step 252 (Get Div), subsequent to the initial step 251, all the parts Key1 to KeyM of data item Key are retrieved from the different secure elements.

At a step 253 (LUT), subsequent to step 252, the previously-described lookup table is used to determine the order in which parts Key1 to KeyM are to be combined. To find out which row corresponds to data item Key, the previously-described counter value can be used.

At a step 254 (Concat), subsequent to step 253, parts Key1 to KeyM are combined, for example concatenated, to obtain data item Key.

At a step 255 (Get Key), after step 254, the data item Key has been retrieved and can be used.

Various embodiments and variants have been described. Those skilled in the art will understand that certain features of these various embodiments and variants may be combined, and other variants will occur to those skilled in the art. In particular, to further improve the security of the storage obtained by method 200, encryption and/or decryption steps may be added.

Finally, the practical implementation of the described embodiments and variants is within the abilities of those skilled in the art based on the functional indications given hereabove.

1. A method of storing a data item in an electronic system comprising at least two secure elements, wherein the method comprises the successive steps of:
dividing the data item into at least two parts; and
distributing and storing each of the at least two parts into one of the at least two secure elements.

2. The method of claim 1, wherein the distributing of the at least two parts into the at least two secure elements is recorded in a row or column of a lookup table.

3. The method of claim 2, wherein the lookup table is stored in a single location of a system accessible to each of the at least two secure elements.

4. The method of claim 2, wherein a copy of the lookup table is stored in each of the at least two secure elements.

5. The method of claim 1, wherein the distributing is different for each data item stored in the system.

6. The method of claim 5, wherein the distributing is selected by selecting a row of a lookup table.

7. The method of claim 6, wherein selecting the row of the lookup table is performed by using a counter.

8. The method of claim 1, wherein each of the at least two secure elements is comprised in at least one operating domain of the system.

9. The method of claim 8, wherein each at least one operating domain further comprises at least one electronic device.

10. The method of claim 1, wherein the at least two secure elements are on-board secure elements.

11. The method of claim 1, wherein the data item is an application key.

12. The method of claim 1, wherein the distributing varies depending on an operating session of the system.

13. The method of claim 1 further comprising the successive steps of:
retrieving the at least two parts of the data item stored in the at least two secure elements; and
forming the data item by using the at least two parts.

14. The method of claim 13, wherein the forming of the data item is performed using a lookup table.

15. An electronic system comprising at least two secure elements and configured for storing a data item by following the successive steps of:
dividing the data item into at least two parts; and
distributing and storing each of the at least two parts into one of the at least two secure elements.

16. The electronic system of claim 15, wherein the distributing of the at least two parts into the at least two secure elements is recorded in a row, or column, of a lookup table.

17. The electronic system of claim 16, wherein the lookup table is stored in a single location of the electronic system accessible to each of the at least two secure elements.

18. The electronic system of claim 16, wherein a copy of the lookup table is stored in each of the at least two secure elements.

19. The electronic system of claim 15, wherein the distributing is different for each data item stored in the system.

20. The electronic system of claim 16, wherein the distributing varies depending on an operating session of the system.
